(19) United States
(12) Patent Application Publication
(10) Pub. No.: US 2005/0213242 A1
(43) Pub. Date: Sep. 29, 2005

(54) Magnetic disk apparatus and information processing apparatus

(75) Inventors: Masao Fujiki, Musashino-shi (JP); Koichi Kobayashi, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/070,504

(22) Filed: Mar. 3, 2005

(30) Foreign Application Priority Data
Mar. 23, 2004 (JP) 2004-084501

(51) Int. Cl. G11B 21/02; G11B 19/04

(52) U.S. Cl. 360/75; 360/60

(57) ABSTRACT

Disclosed is a magnetic disk apparatus comprising a memory storing data received from an external apparatus via an interface, a magnetic head for writing to the magnetic disk the data stored in the memory, a falling detection unit for detecting falling of the magnetic disk apparatus, an acceleration detection unit for detecting acceleration applied to the magnetic disk apparatus, a reception interruption unit for, when the falling detection unit detects the falling, interrupting the sending/receiving operation of the data and command at the interface, interrupting the writing operation of the magnetic head to the magnetic disk, and escape the magnetic head from the magnetic disk, and a reception restoring unit for, after the acceleration detected by the acceleration detection unit lowers under a predetermined value, overwriting to the magnetic disk the data stored in the memory using the magnetic head.

### CROSS-REFERENCE TO RELATED APPLICATIONS

This application is based upon and claims the benefit of priority from prior Japanese Patent Application No. 2004-84501, filed Mar. 23, 2004, the entire contents of which are incorporated herein by reference.

### BACKGROUND OF THE INVENTION

1. Field of the Invention

The present invention relates to a magnetic disk apparatus and an information processing apparatus incorporated with the magnetic disk apparatus, and more particularly to a magnetic disk apparatus capable of ensuring a stable data writing to the magnetic disk apparatus even in an abnormal condition such as falling of the magnetic disk apparatus or the information processing apparatus incorporating with the magnetic disk apparatus.

2. Description of the Related Art

Recently, a magnetic disk apparatus is used in not only in a stationary information processing apparatus but also a portable apparatus such as a portable information processing apparatus. When data is written in the magnetic disk apparatus a so-called “a data writing error” such as erroneous data writing or no data writing should be prevented absolutely.

For example, when a magnetic disk apparatus or an information processing apparatus incorporated with the magnetic disk apparatus falls down and crashes to a floor during data writing is performed in the magnetic disk apparatus, a shock is applied to the magnetic disk apparatus and a relative position between a magnetic head and a truck on the disk will be shifted due to the shock, thereby occurring data writing error. Moreover, when the magnetic disk apparatus falls to the floor, the magnetic head may be touched to the track on the disk and one or both of them may be destroyed.

Another environment change which may cause an operation error such as the data writing error in the magnetic disk apparatus is lowering of an environment temperature under a lower limit temperature. When the environment temperature becomes to the lower limit temperature, the data writing ability of the magnetic head is lowered, and as a result, the data writing error will be occurred.

There is a known method for preventing the writing error when the environment temperature becomes at a value lower than the lower limit temperature. For example, a magnetic disk apparatus is shown in Japanese patent application KOKAI publication No. 2003-141703 (see page 5 and FIG. 6) wherein original data and recorded data are compared with each other to determine whether the writing operation is done normally or not, and when abnormal writing is detected, formal writing operations (dummy writing operations) are repeatedly performed to raise the temperature in the housing of the magnetic disk apparatus to a predetermined temperature which is capable of restarting the normal writing operation.

Generally, in order to prevent the occurrence of the data writing error at the falling down of the magnetic disk apparatus, housings of the magnetic disk apparatus and the information processing apparatus incorporated with the magnetic disk apparatus are designed to have a shock absorbing structure. However, since the attitude of the housing of the magnetic disk apparatus is not be expected, a compact housing having a high performance shock absorbing structure cannot be designed. In other words, since a high performance shock absorbing structure occupies a large space in the housing, it is difficult to design a compact housing for a portable information processing apparatus with the high performance shock absorbing structure.

In a recent magnetic disk apparatus, is widely used a method of writing data in a magnetic disk wherein a predetermined amount of data of the whole data to be written in the magnetic disk is first stored in a temporarily memory device i.e., in a so-called cache memory, and then the data stored in the cache memory is written into the disk, in order to increase the a nominal writing speed.

However, even in a case wherein magnetic disk apparatus provided with the writing cache memory is used, a data writing error may be occurred due to the abnormality of the environment such as the falling down of the magnetic disk apparatus or the lowering of the temperature. For example, when the environment temperature is lowered under a limited value, the data writing operation is stopped instantly even if the magnetic head is driven to write data. As a result, data which has not written in the disk is remained in the writing cache memory and the data writing error is happened.

### BRIEF SUMMARY OF THE INVENTION

The magnetic disk apparatus according to one aspect of the present invention comprising: a magnetic disk; an interface configured to send/receive data and a command with respect to an external device; a memory configured to store temporarily the data received by the interface; a magnetic head configured to write into the magnetic disk the data stored in the memory; an acceleration detection unit configured to detect acceleration; a falling detection unit configured to detect falling; a reception interruption unit configured to, when the falling detection unit detects the falling, interrupt sending/receiving the data and the command at the interface, interrupt writing operation of the magnetic head to the magnetic disk, and escape the magnetic head from the magnetic disk; and a reception restoring unit configured to, after the acceleration detected by the acceleration detection unit lowers under a predetermined value, move the magnetic head onto the magnetic disk to write remaining data which is not written into the magnetic disk of the data stored in the memory using the magnetic head, and reopen the sending/receiving operation of the data and the command at the interface unit after the remaining data is fully written into the magnetic disk.

An information processing apparatus according to another aspect of the present invention comprising: a magnetic disk apparatus including at least a magnetic disk, a memory configured to temporarily store received data, a magnetic head unit configured to write the data stored in the memory into the magnetic disk, and an acceleration detection unit configured to detect acceleration; an interface unit configured to send/receive data and a command; a falling detection unit configured to detect falling; an interruption instruction unit configured to, when the falling detection unit detects the falling, supply an interruption command to the magnetic disk apparatus to interrupt the data storing operation; a reception interruption unit configured to, when the magnetic disk apparatus receives the interruption command from the interruption instruction unit, interrupt sending/receiving of the data and the command to the magnetic disk apparatus from the interface unit, interrupt the writing operation by the magnetic head to the magnetic disk, and escape the magnetic head from the magnetic disk; and reception restoring unit configured to, after the acceleration detected by the acceleration detection unit lowers under a predetermined value, move the magnetic head onto the magnetic disk to write remaining data which is not written into the magnetic disk of the data stored in the memory using the magnetic head, and reopen the sending/receiving operation of the data and the command at the interface after the remaining data is fully written into the magnetic disk.

The magnetic disk apparatus according to another aspect of the present invention comprising: a magnetic disk; an interface configured to send/receive data and a command with respect to an external device; a memory configured to store temporarily the data received by the interface; a magnetic head configured to write into the magnetic disk the data stored in the memory; a temperature detection unit configured to detect environment temperature; a reception interruption unit configured to, when the environment temperature detected by the temperature detection unit goes under a predetermined value, interrupt sending/receiving the data and the command at the interface, and write remaining data which the magnetic head has not written to the magnetic disk of the data stored in the memory; and a reception restoring unit configured to, after the environment temperature detected by the temperature detection unit raises over the predetermined temperature, restart the sending/receiving operation of the data and the command by the interface.

The magnetic disk apparatus according to still another aspect of the present invention comprising: a magnetic disk; an interface configured to send/receive data and a command with respect to an external device; a memory configured to store temporarily the data received by the interface; a magnetic head configured to write into the magnetic disk the data stored in the memory; a voltage detection unit configured to detect a voltage; a reception interruption unit configured to, when the voltage detected by the voltage detection unit goes under a predetermined value, interrupt sending/receiving the data and the command at the interface unit, and write remaining data which the magnetic head has not written to the magnetic disk of the data stored in the memory; and a reception restoring unit configured to, after the voltage detected by the voltage detection unit raises over the predetermined temperature, restart the sending/receiving operation of the data and the command by the interface.

### BRIEF DESCRIPTION OF THE SEVERAL VIEWS OF THE DRAWING

FIG. 1 is a block diagram of a magnetic disk apparatus of a first embodiment of the present invention.

FIG. 2 is a flowchart showing a write control operation of the magnetic disk apparatus shown in FIG. 1.

FIG. 3 is a graph showing an acceleration change occurring when a magnetic disk apparatus falls freely.

FIG. 4 is a block diagram showing a constitution of an information processing apparatus according to another embodiment of the present invention.

FIG. 5 is a flowchart showing a write control operation of the magnetic disk apparatus shown in FIG. 4.

FIG. 6 is a block diagram showing a constitution of still another embodiment of the present invention.

FIG. 7 is a flowchart showing a write control operation of the magnetic disk apparatus shown in FIG. 6 when an environment temperature lowers.

FIG. 8 is a flowchart showing a write control operation of the magnetic disk apparatus shown in FIG. 6 when a source voltage lowers.

FIG. 9 is a graph showing a change of the source voltage with respect to elapsing of time.

### DETAILED DESCRIPTION OF THE INVENTION

Next, embodiments of the present invention will be described in detail with reference to the accompanying drawings.

### First Embodiment

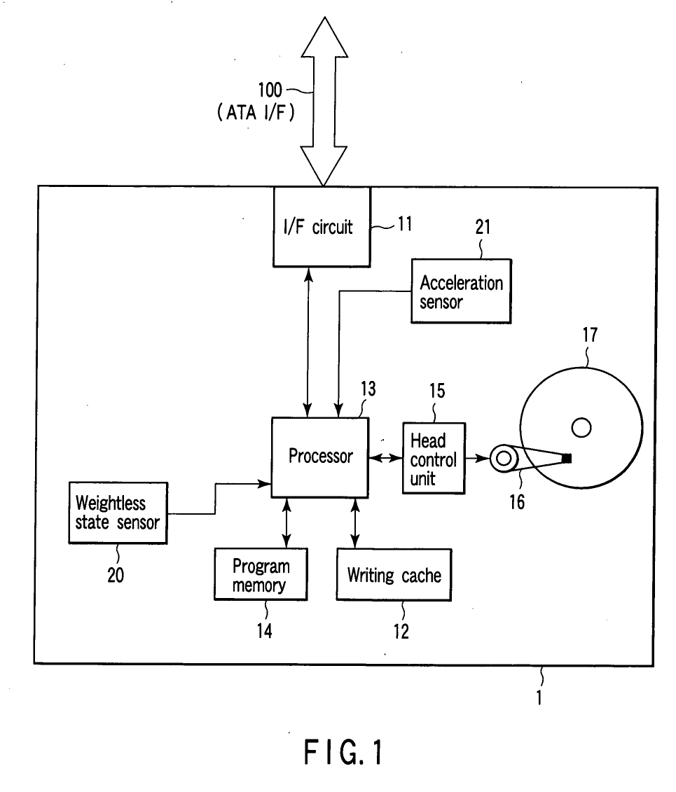

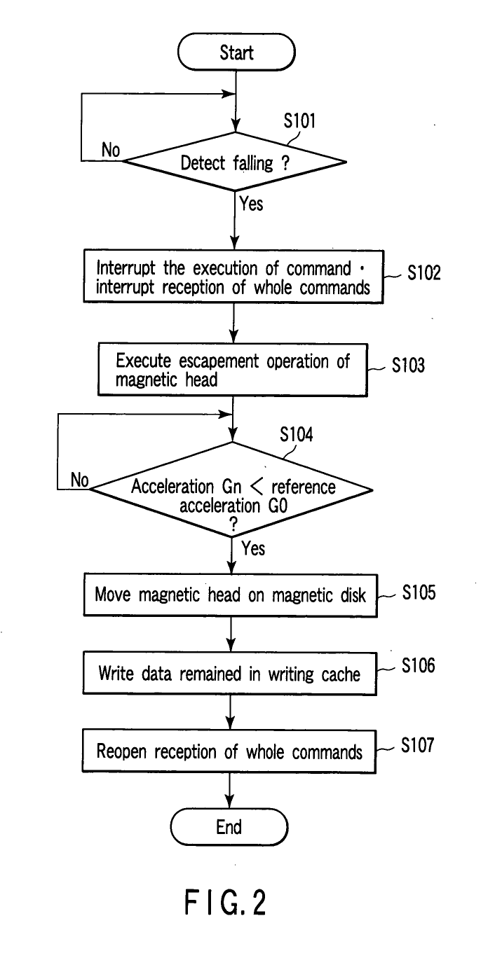

A magnetic disk apparatus according to first embodiment of the present invention will be described by referring to FIG. 1 and FIG. 2. FIG. 1 is a block diagram showing a constitution of the magnetic disk apparatus according to the first embodiment. The magnetic disk apparatus 1 comprises an I/F (interface) circuit 11, a write cache memory 12, a processor 13, a program memory 14, a head control unit 15, a magnetic head 16, a magnetic disk 17, a weightless state sensor 20, and an acceleration sensor 21.

The I/F circuit 11, write cache 12, program memory 14, head control unit 15, weightless state sensor 20 and acceleration sensor 21 are connected to the processor 13. The head control unit 15 is connected with the magnetic head 16. The magnetic disk apparatus 1 is connected with a superior apparatus (not shown) through an attachment interface (herein after referred to as “ATA I/F”) 100.

Now, detailed structures of the respective units shown in FIG. 1 will be explained.

The I/F circuit 11 is a circuit configured to send/receive data with respect to the superior apparatus (not shown) connected through the ATA I/F 100.

The write cache 12 is a memory unit for temporarily storing data to be written in the magnetic disk 17. The write cache 12 is used as a memory area for temporarily storing the data to be written in the magnetic disk 17 received by the magnetic disk apparatus 1 through the ATA I/F 100 before the received data is written in the magnetic disk 17 by the magnetic head 16. By providing the write cache 12 and by storing the data to be written in the magnetic disk 17 in the write cache 12, the magnetic disk apparatus 1 can send/receive new data and command to/from the superior apparatus through the ATA I/F 100, whereby it is possible to operate the magnetic disk apparatus 1 and the superior apparatus efficiently. In this embodiment, the write cache 12 is set to store one sector data having a length equal to a sector of a recording truck of the magnetic disk 17. Accordingly, each sector data to be written in the magnetic disk 17 is sent one by one to the write cache 12 through the I/F circuit 11 from the superior apparatus and is stored in the cache 12. The processor 13 is configured to hold the number of a sector on the magnetic disk 17 each time when corresponding sector data stored in the cache 12 is written in that sector on the magnetic disk 17.

The processor 13 is configured to execute a program stored in the program memory 14 according to a command supplied from the I/F circuit 11.

The program memory 14 stores a program to be executed by the processor 13 which executes data reading process and data writing process which will be described later.

The head control unit 15 is configured to control the magnetic head 16 to read/write data. Thus, the head control unit 15 receives a command supplied from the processor 13 to control the magnetic head 16 so as to write the data stored in the write cache 12 to the magnetic disk 17 or to read out the data recorded in the magnetic disk 17.

The magnetic head 16 is a unit for writing data to the magnetic disk 17 or for reading out the data stored in the magnetic disk 17 under the control of the head control unit 15.

The magnetic disk 17 is a unit for storing data which the magnetic disk apparatus 1 receive.

The weightless state sensor 20 is a unit for detecting the falling of the magnetic disk apparatus 1. The weightless state sensor 20 is configured to output continuously a falling detection signal during the falling of the magnetic disk apparatus 1. The falling detection signal from the sensor 20 is monitored continuously by the processor 13. When the processor 13 detects that the falling detection signal has been continued for a period of time Dn which is longer than a predetermined falling reference period of time D, it is determined that the magnetic disk apparatus 1 is falling. Generally, the attitude of the magnetic disk apparatus 1 during its falling period is not kept constant. Therefore, it is desirable to use an omnidirectional sensor as the weightless state sensor 20 so that the falling of the magnetic disk apparatus 1 can be detected irrespective of the attitude of the falling magnetic disk apparatus 1.

The acceleration sensor 21 is a unit configured to detect the acceleration applied to the magnetic disk apparatus 1 and an omnidirectional sensor is also desirable as the acceleration sensor 21. The acceleration Gn detected by the acceleration sensor 21 is continuously monitored by the processor 13. A reference acceleration G0 is set in the program memory 14, which is compared with the detected acceleration Gn by the processor 13 as will be described later.

The magnetic disk apparatus 1 of the first embodiment is applied to a superior apparatus provided with the magnetic disk apparatus such as a notebook-type personal computer. FIG. 2 shows a flowchart for explaining a write control operation of the magnetic disk apparatus 1 when the superior apparatus or the notebook-type personal computer falls down.

In the first step S101 shown in FIG. 2, the processor 13 of the magnetic disk apparatus 1 monitors continuously whether the weightless state sensor 20 detects the falling of the apparatus 1. The falling may be determined when the processor 13 receives a signal from the weightless state sensor 20 denoting that the falling state is occurring. The falling may also be determined by the processor 13 when a level of a signal denoting that the falling state is occurring is continuously outputted from the weightless state sensor 20 for a predetermined period of time.

When the processor 13 determines that no falling state is detected as shown (No in the step S101), the processor 13 continues its determination until the falling state is detected.

When the processor 13 determines that the falling state is detected by the weightless state sensor 20 (Yes in step S101), the processor 13 interrupts the execution of the ATA commands done by the respective units in the magnetic disk apparatus 1, and also interrupts the receiving operation of the every commands at the I/F circuit 11 (step S102). During the detection of the falling, the acceleration sensor 21 detects the acceleration applied to the magnetic disk apparatus 1.

Then, the processor 13 controls the head control unit 15 to make the magnetic head 16 be escaped from the magnetic disk 17 (step S103). As a result, even if the shock is applied to the magnetic disk apparatus 1 after the magnetic head 16 has escaped, it is possible to prevent the magnetic disk 17 from being damaged by the magnetic head 16. When the magnetic head 16 is driven to escape from the magnetic disk 17, a sector number on the track of the magnetic disk 17 is recorded in the processor 13, and the sector data corresponding sector number is stored temporarily in the write cache 12.

For example, when a notebook-type personal computer incorporated the magnetic disk apparatus 1 of the present embodiment is freely fallen from a position of 30 cm above a surface of a desk, it takes about 250 ms until the computer collides with the desk surface. While, it takes about 100 ms until the processor 13 detects the falling of the magnetic disk apparatus 1 and about 50 ms during which the magnetic head 16 is then driven to escape from the magnetic disk 17. Therefore, the magnetic head 16 can escape from the magnetic disk 17 sufficiently before that the notebook-type personal computer collides with the desk surface.

Then, the processor 13 determines whether the acceleration Gn detected by the acceleration sensor 21 becomes at a value less than the reference acceleration G0 at the step S104. When the computer collides with the floor, for example, a large impact (acceleration) will be given to the computer. Then, the computer rebounds repeatedly at the floor and at last the rebounding will be terminated at which the acceleration becomes at zero. It is a matter of course that the magnetic disk apparatus 1 and the superior apparatus incorporated with the magnetic disk apparatus 1 are designed to have a shock absorbing mechanism in the housing in order to absorb the shock caused by the falling. Therefore, the magnetic disk apparatus 1 is not damaged, even if the magnetic disk apparatus 1 collides with the floor while the magnetic head 16 is kept at the escaped position from the magnetic disk 17.

As has been described above, when the superior apparatus collides with the floor the magnetic disk apparatus 1 is applied with a large acceleration and then the acceleration decreases towards zero. However, since noises are detected at the acceleration sensor 21, the output of the acceleration sensor 21 does not become to zero. Therefore, an acceleration level which is larger than the noise level but has a level near to the zero level is set as the reference acceleration G0.

When the processor 13 determines that the acceleration Gn does not become a value which is smaller than the reference acceleration G0 (No in the step S104), the determination process is continued until it is determined that the acceleration Gn becomes at a level which is less than the reference acceleration G0.

When the processor 13 determines that the acceleration Gn becomes at a level smaller than that of the reference acceleration G0 (Yes at step S104), it is determined that the impact caused by the collision of the magnetic disk apparatus with the floor decreases zero. Then the processor 13 supplies an instruction to the head control unit 15 to make the magnetic head 16 be moved on the magnetic disk 17 (at step S105).

Then, the processor 13 supplies an instruction to the head control unit 15 that the magnetic head 16 writes the data which is remained in the write cache 12 and has not be written in the magnetic disk 17 to the magnetic disk 17. In this embodiment, since the data is written in the magnetic disk 17 as a unit of sector data, the sector data which has been written to the disk 17 when the falling down of the magnetic disk apparatus 1 is detected is fully held in the write cache 12 and the corresponding sector number is also held in the processor 13. Accordingly, the magnetic head 16 is moved to the starting position of the corresponding sector on the magnetic disk 17 under the control of the processor 13 to write the sector data from its heading data. Accordingly, even if the sector data has been written faultily in the magnetic disk 17 when the falling is detected, the corresponding sector data is overwritten to the sector portion from beginning on the track of the magnetic disk 17, thereby preventing the writing error.

When the writing operation of the corresponding sector data to the magnetic disk is completed, the processor 13 restores the reception of the interrupted data and ATA command through the I/F circuit 11 (step S107) and the write control processing of the embodiment is terminated. In the present embodiment, the data writing is performed in the unit of sector. However, the writing data unit is not limited to the sector by sector unit but may be selected to a writing data unit smaller than the sector unit or to a unit larger than the sector unit.

By performing the above-mentioned processing, it is possible to prevent the writing error of the remaining data in the writing cache caused by the writing interruption from being occurred when the falling is detected.

Accordingly, it is possible to perform the data writing to the magnetic disk 17 reliably even in a case where the superior apparatus falls down.

The present invention is applicable not only to the first embodiment wherein the write control is performed at the time of falling but also to some cases wherein the environment change such as the lowering of the source voltage, lowering of the temperature, or the large static electricity is occurred. If one of these environment change is occurred the change is detected similarly and the writing error to the magnetic disk is also prevented in the similar manner. In these cases, the lowering of the source voltage can be detected by a voltage detection unit, the lowering of the temperature can be detected by a temperature detecting unit, and the static electricity can be detected by means of the static electricity detection unit. These detection units may be provided in the magnetic disk apparatus 1.

In the first embodiment the falling state is detected by using the weightless state sensor. Further, the falling can also be detected by an acceleration sensor. A method for detecting the falling by means of the acceleration sensor is known and is explained in detail, for example, in an European Patent Application No. EP 0 658 894 A1. When the falling is detected by using the acceleration sensor, the weightless state sensor shown in FIG. 1 may be omitted.

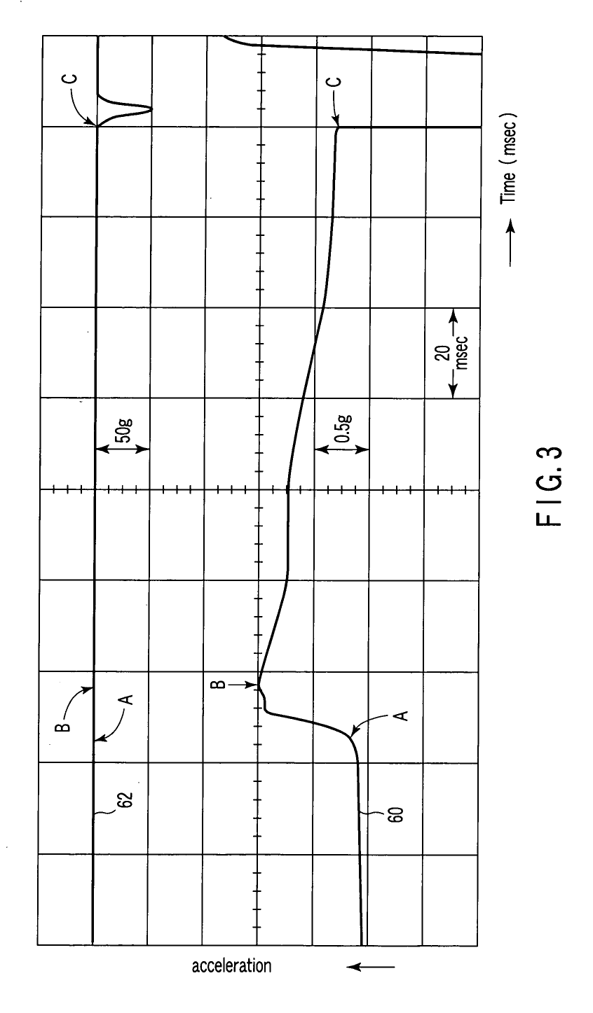

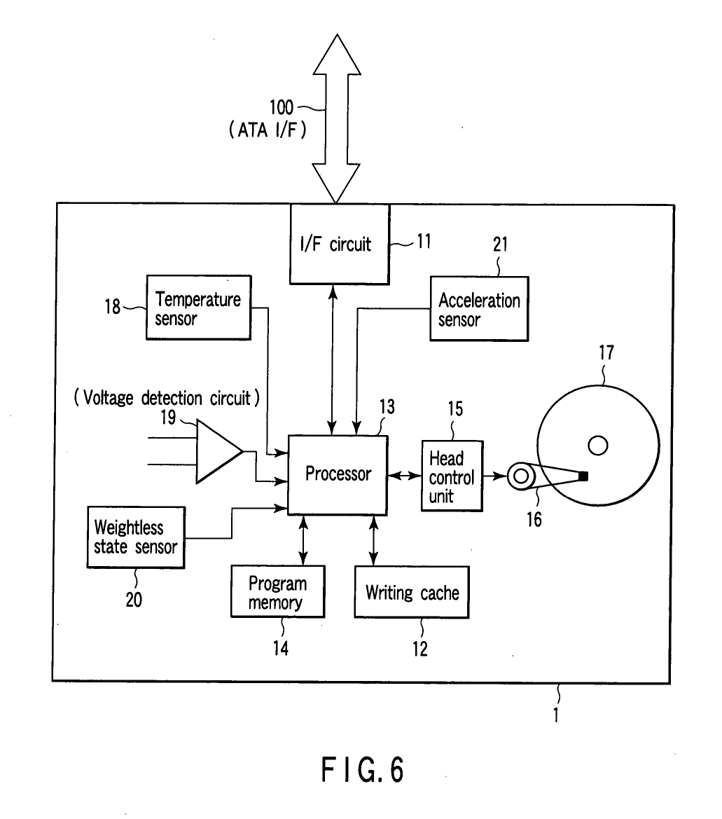

FIG. 3 shows a graph corresponding to that shown in FIG. 6 of the European Patent Application No. EP 0 658 894 A1.

Now, the method for detecting the falling and the acceleration by using a single acceleration sensor will be explained by referring to FIG. 3 in which the acceleration applied to the free falling magnetic disk apparatus is depicted. The ordinate in FIG. 3 shows acceleration and the abscissa shows time (msec). The upper curve 62 is a acceleration profile at a reduced scale wherein each vertical grid segment is 50 g, while the lower curve 60 shows the acceleration profile of an induced scale wherein each vertical grid segment is 0.5 g. In the FIG. 3, g represents the acceleration of gravity at an earth surface and its value is represented as 9.8 m/sec².

As shown in FIG. 3, when the magnetic disk apparatus begins to fall down freely at a time point A, the magnetic disk apparatus receives the acceleration of 1.0 g at point B in the upward direction. Then, when the magnetic disk apparatus collides with the floor at point C, a large acceleration is applied to the magnetic disk apparatus in the downward direction. As can be seen from FIG. 3, when the acceleration applied to the magnetic disk apparatus is beyond a predetermined reference acceleration in the upward direction as shown at point B, it is possible to determine that the free fall has been occurred. In the EP 0 658 894 A1, a value a_{TL} from 0.4 g to 1.0 g is preferable as the predetermined reference acceleration value for detecting the free fall. The value of this reference acceleration a_{TL} for the falling detection is larger than that of the reference acceleration G0 defined in the first embodiment for detecting that the impact applied to the magnetic disk apparatus caused by its free fall has been attenuated. Some amount of acceleration caused from a vibration will be applied to the magnetic disk apparatus when this magnetic disk apparatus or the superior apparatus thereof is carried by a user's hand and the vibration is applied to the magnetic disk apparatus. In order to discriminate this vibration and the free fall, it is preferable to determine the falling when a predetermined level (a_{TL}) or more acceleration is continuously detected for a prescribed period of time, as has been described in detail in the first embodiment. In the description of the EP 0 658 894 A1, a reference time period tref of approximately 90 msec is set for the prescribed period of time so as to effectively discriminate between the vibration and the falling.

### Second Embodiment

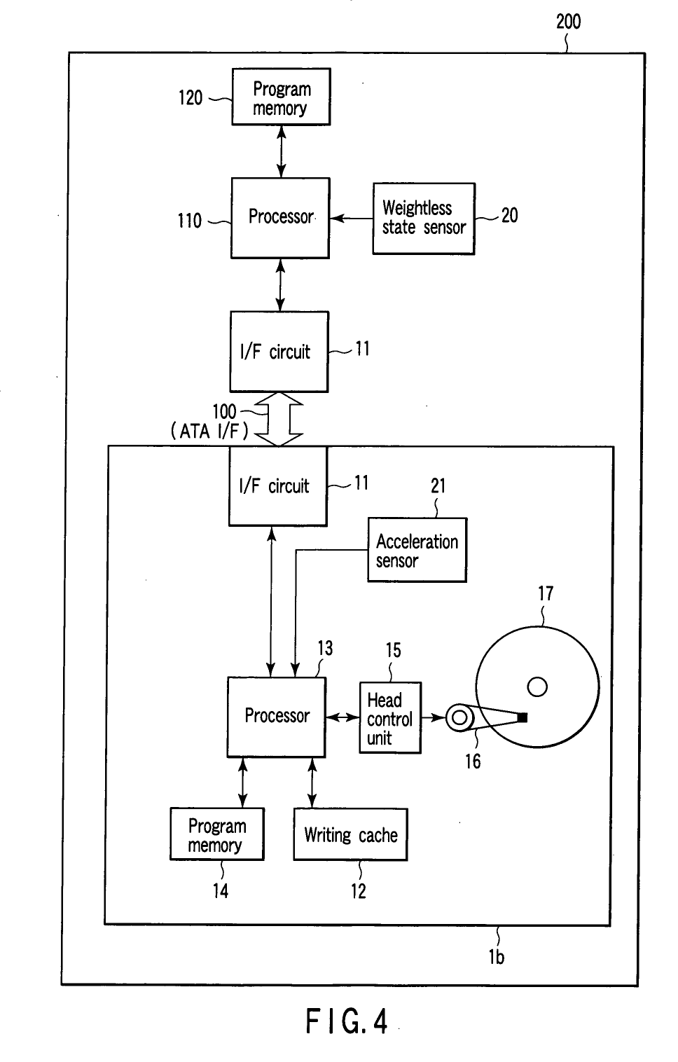

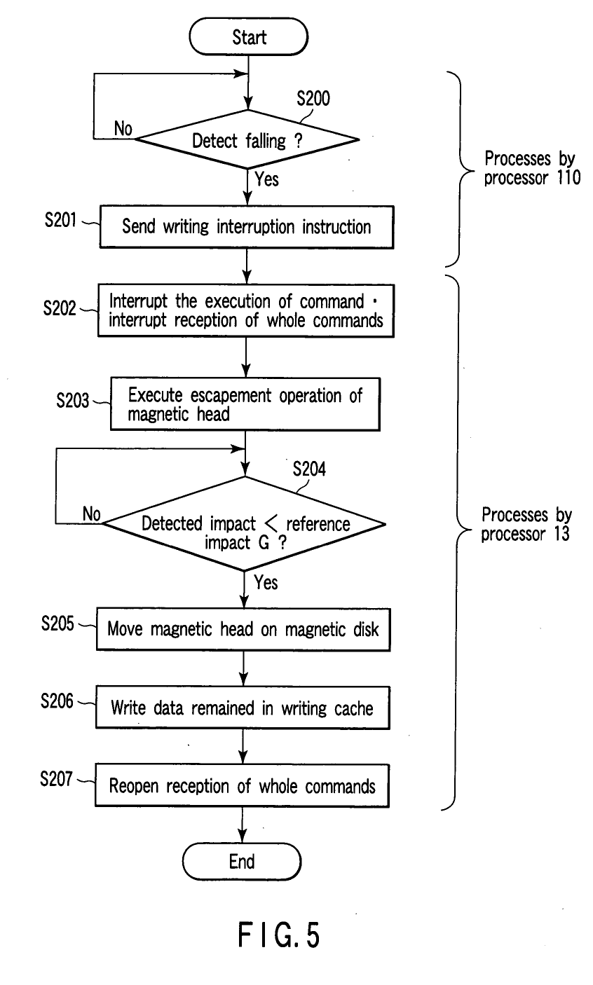

The second embodiment will be described by referring to FIGS. 4 and 5. FIG. 4 shows a block diagram of an information processing apparatus according to the second embodiment. In this second embodiment, the weightless state sensor provided in the magnetic disk apparatus 1 is moved to the information processing apparatus so that an output of the weightless state sensor is monitored by a processor in the information processing apparatus and that the falling can be detected by the processor.

In FIG. 4, the elements or units similar to those in the magnetic disk apparatus shown in FIG. 1 are denoted by the same or similar reference numerals and a detailed explanation thereof may be omitted.

In FIG. 4, an information processing apparatus 200 such as a notebook-type personal computer comprises a weightless state sensor 20, a processor 110, a program memory 120, an I/F circuit 11 and a magnetic disk apparatus lb. Of these units, the weightless state sensor 20, the program memory 120 and the I/F circuit 11 are connected to the processor 110. The I/F circuit 11 is connected to the magnetic disk apparatus 1b through an ATA I/F 100.

Now, the constitutions of the respective units in FIG. 4 will be described.

The processor 110 is configured to execute the program stored in the program memory 120 to control the whole operations in the information processing apparatus 200.

The program memory 120 stores a program being executed by the processor 110.

The magnetic disk apparatus 1b has a similar constitution except for the fact that the weightless state sensor 20 is not provided in the magnetic disk apparatus. Namely, when the magnetic disk apparatus 1 is made compact, no space for the weightless state sensor 20 is prepared in the housing of the magnetic disk apparatus 1. In the second embodiment, the weightless state sensor 20 is mounted in the superior apparatus or the information processing apparatus 200 so that the similar advantage can be achieved in the second embodiment. In the second embodiment, the elements in the magnetic disk apparatus 1b and corresponding elements in the magnetic disk apparatus 1 of the first embodiment are denoted by the similar or the same reference numerals and the explanation thereof is omitted here.

Now, the writing control at a case where the information processing apparatus 200 falls down will be described by referring to FIG. 5 which is a flowchart for explaining the writing operation when the information processing apparatus 200 falls down. In the figure, the steps similar to those shown in FIG. 2 are denoted by the similar reference symbols and the explanation thereof is omitted.

In FIG. 5, the processor 110 provided in the information processing apparatus 200 determines continuously whether the weightless state sensor 20 detects the falling of the apparatus 200 (step S200). As in the case of FIG. 2, the falling may be determined when the processor 13 receives a signal from the weightless state sensor 20 denoting that the falling state is occurring. The falling may also be determined by the processor 13 when a level of a signal denoting that the falling state is occurring is continuously outputted from the weightless state sensor 20 for a predetermined period of time.

When the processor 110 determines that no falling is detected by the sensor 20 (No in the step S200), the processor 110 continues its determination process until the falling is detected by the weightless state sensor 20.

When the processor 110 determines that the weightless state sensor 20 has detected the falling of the apparatus 200 (Yes in the step S200), the processor 110 send an instruction to instantly interrupt the data writing to the magnetic disk apparatus 1b through the I/F circuit 11 (step S201). The steps S200 to S201 are processes executed by the information processing apparatus 200 as a superior apparatus.

When the processor 13 in the magnetic disk apparatus 1b receives the instruction generated at the step S201, the processor 13 executes the processes in the steps S202 to S207 including an interruption process making the respective elements stop the execution of the ATA command. Since these steps are the same as those in the first embodiment shown in FIG. 2, the explanations thereof are omitted here.

By performing the above-mentioned processing, it is possible to prevent the writing error of the remaining data in the writing cache caused by the writing interruption from being occurred when the falling is detected.

Thus, it is possible to write data in the magnetic disk reliably even in the case where an environment change or falling state occurs to the information processing apparatus 200.

In the second embodiment the weightless state sensor 20 is mounted in the superior apparatus. However, according to the present invention, the position of the weightless state sensor 20 is not limited to the superior apparatus. For example, when the acceleration sensor 21 shown in FIG. 4 is also mounted in the superior apparatus or the information processing apparatus 200, the magnetic disk apparatus 1b may be made more compact.

Further embodiments according to the present invention will be explained by referring to the drawing. These embodiments are configured to be able to write data reliably even in a case when the magnetic disk apparatus 1 is positioned in an environment temperature lower than the predetermined temperature at which the magnetic disk apparatus 1 is not operate normally or in a case when the source voltage supplied to the magnetic disk apparatus 1 is lowered to a value at which the magnetic disk apparatus is not operate normally. FIG. 6 shows a configuration having a temperature sensor 18 and a voltage detection circuit 19 added to the apparatus shown in FIG. 1 embodiment. In this FIG. 6, the temperature sensor 18 and the voltage detection circuit 19 are provided in addition to the weightless state sensor 20 and the acceleration sensor 21. However, it is possible to configure a constitution which is provided with only the temperature sensor 18 or a constitution which is provided with only the voltage detection circuit 19 in the magnetic disk apparatus, without providing the weightless state sensor 20 and acceleration sensor 21. In this FIG. 5, these elements are provided in the same magnetic disk apparatus for the sake of the simplicity.

### Third Embodiment

The constitution of this embodiment shown in FIG. 6 has that shown in FIG. 1 except for the provision of a temperature sensor 18 connected to the processor 13 in the magnetic disk apparatus 1 in which the corresponding elements are denoted by the same reference numerals and the detailed explanation is omitted.

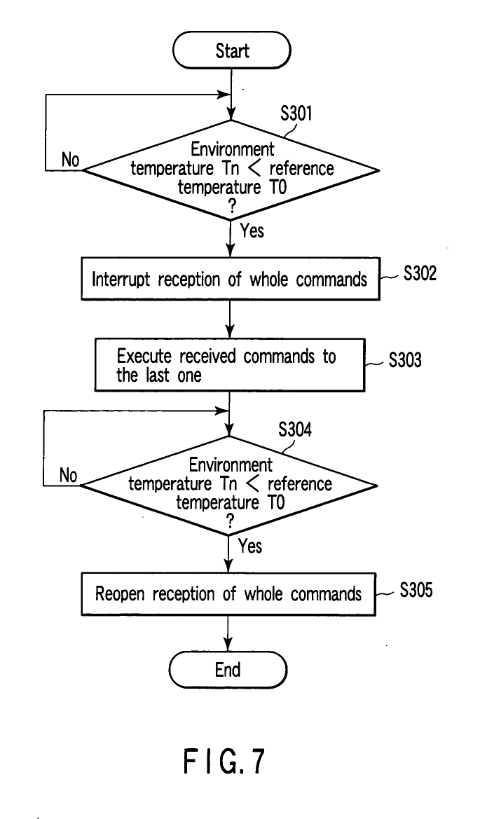

The data write control, in a case when the environment temperature Tn detected by the temperature sensor 18 is lowered near a lower limit temperature (lower limit temperature Tmin) at which the magnetic head 16 can write data correctly in the magnetic disk 17, will be described in detail by referring to FIGS. 6 and 7. FIG. 7 is a flowchart for explaining the write control of the magnetic disk apparatus when the environment temperature Tn lowers near the lower limit temperature Tmin.

The temperature sensor 18 is a unit for detecting the environment temperature Tn around the magnetic disk apparatus 1. The signal delivered from the temperature sensor 18 denoting the environment temperature Tn is supplied to the processor 13 which continuously monitors the temperature Tn. A reference temperature T0 is set in the program memory 14, which is compared with the environment temperature Tn by the processor 13.

In the flowchart shown in FIG. 7, the processor 13 in the magnetic disk apparatus 1 checks whether the environment temperature Tn detected by the temperature sensor 18 becomes at a temperature lower than the reference temperature T0 (step S301). Where, the reference temperature T0 is a preset temperature set in the program memory 14, which temperature T0 is set to be a value higher than the lower limit temperature Tmin by a predetermined value. The predetermined value should be defined at a low temperature range in which the data remained in the write cache 12 still can be written in the magnetic disk 17 reliably. Accordingly, if the temperature lowering speed is high or if the data storing capacity of the write cache 12 is large, the predetermined value should be set at a higher temperature.

During the processor 13 determines that the environment temperature Tn is not lower than the reference temperature T0 (No, in the step S301), the processor 13 continues its check until the environment temperature Tn becomes at a temperature lower than the reference temperature T0.

When the processor 13 determines that the environment temperature Tn becomes at a value lower than the reference temperature T0 (Yes in the step S301), the processor 13 lets the I/F circuit 11 stop to receive the whole commands with respect to the ATA command (step S302).

Then, the processor 13 executes the ATA command which is received up to the step S302 via the ATA I/F 100 at the respective elements so as to complete the received command (step S303). By so doing, data remained in the write cache 12 and being written in one sector on the magnetic disk 17 is completely written in the predetermined sector on the magnetic disk 17.

Then, the processor 13 determines whether the environment temperature Tn detected by the temperature sensor 18 has reached at a value higher than the reference temperature T0 (in step S304). Namely, after the environment temperature Tn is detected to be lower than the reference temperature T0 at the step S301, the environment temperature Tn then raises. In the step S304, the temperature Tn is checked whether it is over the reference temperature T0. When it is determined by the processor 13 that the environment temperature Tn has a value not higher than the reference temperature T0 (No, in the step S304), the check by the processor 13 is continued until the temperature Tn becomes over the temperature T0.

When it is determined by the processor 13 that the environment temperature Tn becomes at a value higher than the reference temperature T0 (Yes at step S304), the processor 13 let the I/F circuit 11 reopen the receiving process of the whole commands at the ATA command (at step S305), and the process shown in FIG. 7 is completed.

At this state, the magnetic disk apparatus writes data in a sector following the sector on the magnetic disk into which the sector data at the time when the environment temperature lowers under the reference temperature is written. If nonuse data which has been written in the magnetic disk 17 by means of the magnetic head 16 remains on a track, newly data being written may be overwritten on the nonuse data, thereby erasing the nonuse data and the newly data can be written in the magnetic disk 17.

Generally, in a magnetic disk apparatus 1, the data writing ability of the magnetic head 16 will be lowered when the environment temperature Tn is lowered. When the environment temperature Tn becomes at a value lower than the lower limiting temperature Tmin, it is not possible to overwrite new data on the already written data under such a low temperature environment. If such an overwriting operation is done, the already written data will be remained on the disk in addition to the newly written data, thereby occurring data writing error. On the other hand, according to the present embodiment, when the write control shown in the flowchart shown in FIG. 7 is performed, it is possible to completely write the whole data remained in the write cache 12 before the data write ability of the magnetic disk apparatus lowers. In other words, even if environment change or the environment temperature change around the magnetic disk apparatus occurs largely, it is possible to write data reliably without any error.

### Fourth Embodiment

Now, a fourth embodiment of the present invention will be explained by referring to FIGS. 6, 8 and 9. Since the constitution of this fourth embodiment can be explained by referring to FIG. 6, the detailed explanation thereof may be omitted here.

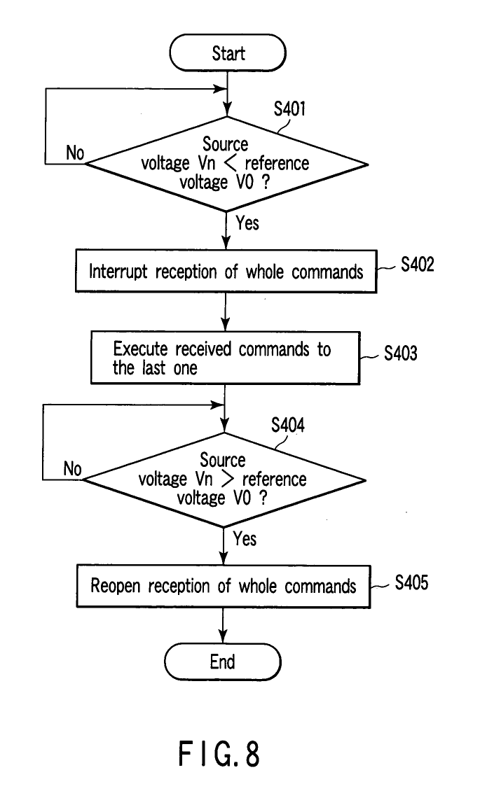

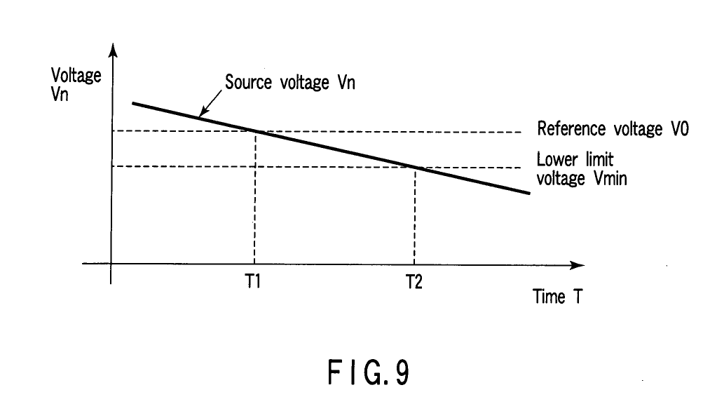

This fourth embodiment is provided with a voltage detection circuit in the structure shown in FIG. 1. This embodiment shown in FIG. 6 is configured to perform data write control when a source voltage Vn of the magnetic disk apparatus 1 detected by the voltage detection circuit 19 is lowered near a lower limit voltage (lower limit voltage Vmin) at which the magnetic disk apparatus 1 can be driven. This write control operation will be described in detail by referring to FIGS. 8 and 9. FIG. 8 is a flowchart showing the write control operation in the magnetic disk apparatus 1 when the source voltage is lowered near the lower limit voltage Vmin.

In FIG. 8, the processor 13 determines whether the source voltage Vn detected by the voltage detection circuit 19 is lowered under the reference voltage V0 (step S401). The reference voltage V0 is a voltage preset in the program memory 14, which has a value higher than the lower limit voltage by a predetermined value. This predetermined value should be set at a value at which the data remained in the write cache 12 can be written reliably in the magnetic disk 17. Accordingly, the predetermined value should be set at a sufficient high voltage when the voltage lowering speed is high or the data storing capacity of the write cache 12 is designed to be large.

When the processor 13 determines that the source voltage Vn is not lower than the reference value V0 (No, at the step S401), the processor 13 continuously check the process of step S401 until it is determined that the source voltage Vn becomes at a value lower than the reference voltage V0.

When the processor 13 determines that the source voltage Vn is lowered under the reference voltage V0 (Yes at the step S401), the processor 13 let the I/F circuit 11 stop the reception of the whole commands of the ATA command (step S402).

Then, the processor 13 executes the ATA command received via the ATA I/F100 until the process of the step S402 in the respective elements, until the execution is completed (step S403). As a result, the sector data, for example, remained in the write cache 12 is completely written in the magnetic disk 17.

Next, the processor 13 checks whether the source voltage Vn detected by the voltage detection circuit 19 becomes at a value higher than the reference voltage V0 (step S404). The source voltage Vn once lowered under the reference voltage V0 at the step S401. The source voltage Vn is increased if a battery voltage is recovered or the battery is charged to increase from that lowered voltage which is then checked by the processor 13 whether it becomes over the reference voltage V0. When the processor 13 determines that the voltage Vn is not higher than the reference voltage V0, the determination process is continued until the voltage Vn becomes at a value higher than the reference voltage V0.

When it is determined by the processor 13 that the source voltage recovers at a value higher than the reference voltage V0 (step S404), the processor 13 let the I/F circuit 11 reopen the reception of the whole commands of the ATA command (step S405), to terminate the process shown in FIG. 8.

By executing the above-mentioned processes, it is possible to prevent the write error from being occurred even when the source voltage is lowered to the lower limit voltage Vmin in the magnetic disk apparatus. In the conventional apparatus, if the source voltage is lowered to the lower limit voltage, the writing operation is interrupted even if the data stored in the write cache is not completely written with some amount of data being remained in the cache.

Accordingly, it is possible to write data to the magnetic disk reliably even if the environment change or the lowering of the source voltage over a predetermined value.

The information processing apparatus provided with the magnetic disk apparatus 1 may be driven by a commercial source voltage or by a battery such as a battery pack so that the apparatus can be used as a portable type apparatus.

FIG. 9 is a graph showing a source voltage change with respect a time when a battery is used in the magnetic disk apparatus 1. In FIG. 9, the ordinate shows a time T and the abscissa shows a source voltage Vn detected by the voltage detection circuit 19. As shown in FIG. 9, when the capacity of the battery is lowered, the source voltage Vn also decreases gradually. Thus, the source voltage Vn decreases slowly with the lapse of time. The source voltage Vn is lowered near the reference voltage V0 at time T1. When time T2 comes, the source voltage Vn is lowered as low as the lower limit voltage Vmin. The source voltage Vn is furthermore lowered beyond the time T2. This voltage lowering may be occurred when a battery is used as a driving source of a superior apparatus provided with the magnetic disk apparatus 1. The time period between the time T1 and time T2 is not a short period of time such as one second but a comparative long period of time such as several tens seconds or more during which the source voltage decreases slowly.

The embodiments shown in FIGS. 6 to 8 are configured to have a function which can control the data writing when the environment change occurs slowly like the temperature change or the voltage change as shown in FIG. 9. Namely, when the environment change occurs slowly, it is possible to secure a sufficient period of time for writing data remained in the write cache 12 to the magnetic disk 17.

In view of the above-mentioned situation, the present invention can be applicable not only to the data write control described in the above-mentioned embodiments where the environment temperature change or the source voltage change occurs, but also to the data write control in the magnetic disk apparatus 1 when the environment around the apparatus changes slowly such as a humidity change. In the case of the humidity change, it is possible to configure a magnetic disk apparatus provided with an element which can detect the humidity.

There is a case where the temperature change or the voltage change occurs at a relatively fast speed around the magnetic disk apparatus. In such a case, the change speed of these physical amount may be monitored by the processor 13 shown in FIG. 6. When the processor 13 detects that the change speed is larger than a predetermined value, the data writing operation to the magnetic disk may be stopped instantly as in the embodiments of FIG. 1 or FIG. 4. After the temperature or voltage is detected to be recovered, the data may be overwritten from the head position of the sector, for example, at which the write operation has been interrupted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A magnetic disk apparatus comprising:
a magnetic disk;
an interface configured to send/receive data and a command with respect to an external device;
a memory configured to store temporarily the data received by the interface;
a magnetic head configured to write into the magnetic disk the data stored in the memory;
a falling detection unit configured to detect falling;
an acceleration detection unit configured to detect acceleration;
a reception interruption unit configured to, when the falling detection unit detects the falling, interrupt sending/receiving the data and the command at the interface unit, interrupt writing operation of the magnetic head to the magnetic disk, and escape the magnetic head from the magnetic disk; and
a reception restoring unit configured to, after the acceleration detected by the acceleration detection unit lowers under a predetermined value, move the magnetic head onto the magnetic disk to write remaining data which is not written into the magnetic disk of the data stored in the memory using the magnetic head, and reopen the sending/receiving operation of the data and the command at the interface after the remaining data is fully written into the magnetic disk.

2. A magnetic disk apparatus according to claim 1, wherein the memory is configured to store the data at a unit of sector of the magnetic disk.

3. A magnetic disk apparatus according to claim 2, wherein the reception interruption unit includes a holding unit configured to, when the falling detection unit detects the falling, hold the data at a unit of sector stored in the memory and a sector number of a sector in the magnetic disk to which the data writing process is executed.

4. The magnetic disk apparatus according to claim 3, wherein the reception restoring unit includes an overwriting unit configured to, after the acceleration detected by the acceleration detection unit is lowered under a predetermined acceleration, and after the magnetic head is moved to a corresponding position based on the sector number held in the holding unit, overwrite the data stored in the memory from a beginning of the sector.

5. A magnetic disk apparatus comprising:
a magnetic disk;
an interface configured to send/receive data and a command with respect to an external device;
a memory configured to store temporarily the data received by the interface;
a magnetic head configured to write into the magnetic disk the data stored in the memory;
an acceleration detection unit configured to detect falling and acceleration applied to the magnetic disk apparatus;
a reception interruption-unit configured to, when the acceleration detection unit detects the falling, interrupt sending/receiving the data and the command at the interface, interrupt writing operation of the magnetic head to the magnetic disk, and escape the magnetic head from the magnetic disk; and
a reception restoring unit configured to, after the acceleration detected by the acceleration detection unit lowers under a predetermined value, move the magnetic head onto the magnetic disk to write remaining data which is not written into the magnetic disk of the data stored in the memory using the magnetic head, and reopen the sending/receiving operation of the data and the command at the interface after the remaining data is fully written into the magnetic disk.

6. A magnetic disk apparatus according to claim 5, wherein the memory is configured to store the data at a unit of sector of the magnetic disk.

7. A magnetic disk apparatus according to claim 6, wherein the reception interruption unit includes a holding unit configured to, when the acceleration detection unit detects the falling, hold the data at a unit of sector stored in the memory and a sector number of a sector in the magnetic disk to which the data writing process is executed.

8. The magnetic disk apparatus according to claim 7, wherein the reception restoring unit includes an overwriting unit configured to, after the acceleration detected by the acceleration detection unit is lowered under a predetermined acceleration, and after the magnetic head is moved to a corresponding position based on the sector number held in the holding unit, overwrite the data stored in the memory from a beginning of the sector.

9. An information processing apparatus comprising:
a magnetic disk apparatus including at least a magnetic disk, a memory configured to temporarily store received data, a magnetic head configured to write the data stored in the memory into the magnetic disk, and an acceleration detection unit configured to detect acceleration;
an interface unit configured to send/receive data and a command;
a falling detection unit configured to detect falling;
an interruption instruction unit configured to, when the falling detection unit detects the falling, supply an interruption command to the magnetic disk apparatus the data storing interruption operation;
a reception interruption unit configured to, when the magnetic disk apparatus receives the interruption command from the interruption instruction unit, interrupt sending/receiving of the data and the command to the magnetic disk apparatus from the interface, interrupt the writing operation by the magnetic head to the magnetic disk, and escape the magnetic head from the magnetic disk; and
a reception restoring unit configured to, after the acceleration detected by the acceleration detection unit lowers under a predetermined value, move the magnetic head onto the magnetic disk to write remaining data which is not written into the magnetic disk of the data stored in the memory using the magnetic head, and reopen the sending/receiving operation of the data and the command at the interface after the remaining data is fully written-into the magnetic disk.

10. A magnetic disk apparatus according to claim 9, wherein the memory is configured to store the data at a unit of sector of the magnetic disk.

11. A magnetic disk apparatus according to claim 10, wherein the reception interruption unit includes a holding unit configured to, when the falling detection unit detects the falling, hold the data at a unit of sector stored in the memory and a sector number of a sector in the magnetic disk to which the data writing process is executed.

12. The magnetic disk apparatus according to claim 11, wherein the reception restoring unit includes an overwriting unit configured to, after the acceleration detected by the acceleration detection unit is lowered under a predetermined acceleration, and after the magnetic head is moved to a corresponding position based on the sector number held in the holding unit, overwrite the data stored in the memory from a beginning of the sector.

13. The magnetic disk apparatus comprising:
a magnetic disk;
an interface configured to send/receive data and a command with respect to an external device;
a memory configured to store temporarily the data received by the interface;
a magnetic head configured to write into the magnetic disk the data stored in the memory;
a temperature detection unit configured to detect environment temperature;
a reception interruption unit configured to, when the environment temperature detected by the temperature detection unit goes under a predetermined value, interrupt sending/receiving the data and the command at the interface unit, interrupt writing operation by the magnetic head to the magnetic disk, and write remaining data which the magnetic head has not written to the magnetic disk of the data stored in the memory; and
a reception restoring unit configured to, after the environment temperature detected by the temperature detection unit raises over the predetermined temperature, restart the sending/receiving operation of the data and the command by the interface.

14. A magnetic disk apparatus according to claim 13, wherein the memory is configured to store the data at a unit of sector of the magnetic disk.

15. The magnetic disk apparatus comprising: a magnetic disk;
an interface configured to send/receive data and a command with respect to an external device;
a memory configured to store temporarily the data received by the interface unit;
a magnetic head configured to write into the magnetic disk the data stored in the memory;
a voltage detection unit configured to detect a voltage;
a reception interruption unit configured to, when the voltage detected by the voltage detection unit goes under a predetermined value, interrupt sending/receiving the data and the command at the interface, and write remaining data which the magnetic head has not written to the magnetic disk of the data stored in the memory; and
a reception restoring unit configured to, after the voltage detected by the voltage detection unit raises over the predetermined temperature, restart the sending/receiving operation of the data and the command by the interface.

16. A magnetic disk apparatus according to claim 15, wherein the memory is configured to store the data at a unit of sector of the magnetic disk.

17. A magnetic disk apparatus comprising:
a magnetic disk;
an interface configured to send/receive data and a command with respect to an external device;
a memory configured to store temporarily the data received by the interface;
a magnetic head configured to write in to the magnetic disk the data stored in the memory;
a falling detection unit configured to detect falling;
an acceleration detection unit configured to detect acceleration;
reception interruption means for, when the falling detection unit detects the falling, interrupting sending/receiving the data and the command at the interface, interrupting writing operation of the magnetic head to the magnetic disk, and escaping the magnetic head from the magnetic disk; and
reception restoring means for, after the acceleration detected by the acceleration detection unit lowers under a predetermined value, moving the magnetic head onto the magnetic disk to write remaining data which is not written into the magnetic disk of the data stored in the memory using the magnetic head, and reopening the sending/receiving operation of the data and the command at the interface after the remaining data is fully written into the magnetic disk.
